(19) United States
(12) Patent Application Publication
(10) Pub. No.: US 2007/0030273 A1
(43) Pub. Date: Feb. 8, 2007

(54) Method of serially connecting animation groups for producing computer game

(75) Inventors: Tseng Guo Chen, Taipei City (TW); Yen Szu Hsiao, Taipei City (TW)

Correspondence Address: TROXELL LAW OFFICE PLLC, SUITE 1404, 5205 LEESBURG PIKE, FALLS CHURCH, VA, 22041, US

(73) Assignee: Lager Interactive Inc.

(21) Appl. No.: 11/198,273

(22) Filed: Aug. 8, 2005

(51) Int. Cl. G06T 15/70; G06T 13/00

(52) U.S. Cl. 345/473; 345/474; 345/949

(57) ABSTRACT

Provided is a method for producing a computer game comprising setting connecting frames between a starting frame and an intermediate key frame and connecting frames between the intermediate key frame and an ending frame of an animation file, producing intermediate animation groups of a series of stages of movement between the starting and ending frames, numbering the animation groups, creating an animation database containing the animation groups each having a first frame identical to one connecting frame and a last frame identical to another connecting frame, instructing a game engine to search the animation database, finding a starting frame of the animation file the same as that indicated by the instruction, randomly selecting a subsequent frame associated with the starting frame, and serially connecting the starting and subsequent frames. The invention can greatly save disk space.

### BACKGROUND OF THE INVENTION

1. Field of Invention

The present invention relates to computer game design and more particularly to a method of serially connecting a plurality of (e.g., two) animation groups of a series of stages of movement for producing a computer game so as to, for example, save disk space.

2. Related Art

Conventionally, computer game software (e.g., 3D MAX, Lightwave, or MAYA) is employed to produce a computer game in which an animation group of a series of stages of movement are stored as file in a computer game in advance. Further, the animation file is adapted to show the animation group when the computer game is running.

The animation file comprises three-dimensional coordinate parameters representing a complete series of stages of movement. For example, a created animation file may comprise a starting stage of movement, three continuous intermediate stages of movement, and an ending stage of movement of a series of stages of movement when one part wants to attack the counterpart by sword three times. Each of three-dimensional coordinate parameters in the animation file is represented by a frame. Thus, the number of frames increases as the number of attacks increases. That is, more time is spent in completing the animation file and thus there are more frames between the starting stage of movement and the ending stage of movement.

However, the prior art suffered from a couple of disadvantages. For example, an attack has ten stages of movement each requiring the creation of an animation subprogram. However, creation of an animation subprogram is a labor intensive and time consuming process. Thus, the production cost is increased significantly. Moreover, more complicated actions are required as quality of computer game is required to improve for meeting the increasing user needs. This in turn may increase the number of subprograms of a complete animation file, i.e., occupy more disk space (e.g., many current types of computer game have 1 GB memory or more). Such may decrease computer performance while playing a computer game. Thus, a need for improvement exists.

### SUMMARY OF THE INVENTION

It is therefore an object of the present invention to provide a method of producing a computer game for saving disk space.

The above and other objects of the present invention are realized by providing a method for producing a computer game comprising setting a plurality of connecting frames between a starting frame and an intermediate key frame and a plurality of connecting frames between the intermediate key frame and an ending frame of an animation file to be created for playing the computer game; producing a plurality of intermediate animation groups of a series of stages of movement between the starting frame and the ending frame; numbering the animation groups; creating an animation database containing the animation groups each having a first frame identical to one connecting frame and a last frame identical to another connecting frame; instructing a game engine to search the animation database; finding a starting frame of the animation file the same as that indicated by the instruction; randomly selecting a subsequent frame associated with the starting frame; and serially connecting the starting frame and the subsequent frame.

The above and other objects, features and advantages of the present invention will become apparent from the following detailed description taken with the accompanying drawings.

### BRIEF DESCRIPTION OF THE DRAWINGS

FIG. 1 is a flowchart depicting a process of serially connecting animation groups for producing a computer game according to a preferred embodiment of the invention;

FIG. 2 schematically depicts an animation connection table containing starting frames and intermediate key frames and associated elements of two attacks of a computer game according to the invention;

FIG. 3 schematically depicts an animation database containing a plurality of animation groups and associated elements according to the invention; and

FIG. 4 schematically depicts a portion of two animation groups of a series of stages of movement when an attack of a computer game is being taken according to the invention.

### DETAILED DESCRIPTION OF THE INVENTION

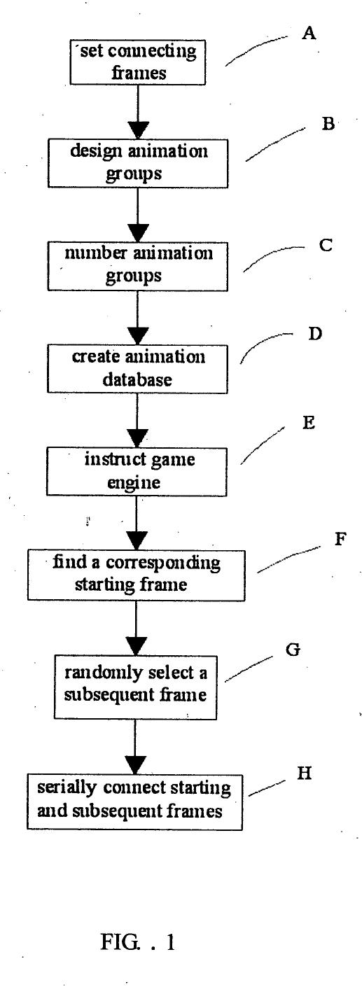

Referring to FIG. 1, a flowchart depicting a process according to a preferred embodiment of the invention is illustrated. In step A, connecting frames between a starting frame and an intermediate key frame and connecting frames between the intermediate key frame and an ending frame of an animation file to be created are set. In step B, a plurality of intermediate animation groups of a series of stages of movement between the starting frame and the ending frame are produced. In step C, give a number to each of the animation groups. In step D, create an animation database containing the animation groups each having a first frame identical to one connecting frame and a last frame identical to the other connecting frame. In step E, a game engine is instructed to search the animation database. In step F, a starting frame of the animation file having a key ID the same as that indicated by the instruction is found. In step G, a subsequent frame associated with the starting frame is selected randomly. In the final step H, the starting frame and the subsequent frame are serially connected. This completes the process of producing a computer game.

For example, m (m is a number larger than one) animation groups are set between a starting frame (i.e., first connecting frame) and an intermediate key frame (i.e., second connecting frame) of an attack of a computer game and n (n is a number larger than one) animation groups are set between the intermediate key frame (i.e., second connecting frame) and an ending frame (i.e., third connecting frame) of the same respectively. Hence, there are m×n combinations (i.e., the number of a complete series of stages of movement is m×n) between the starting frame and the ending frame. That is, the number of animation variations is m×n. Advantageously, only m+n subprograms are required to store in disk. Thus, it can greatly save storage space.

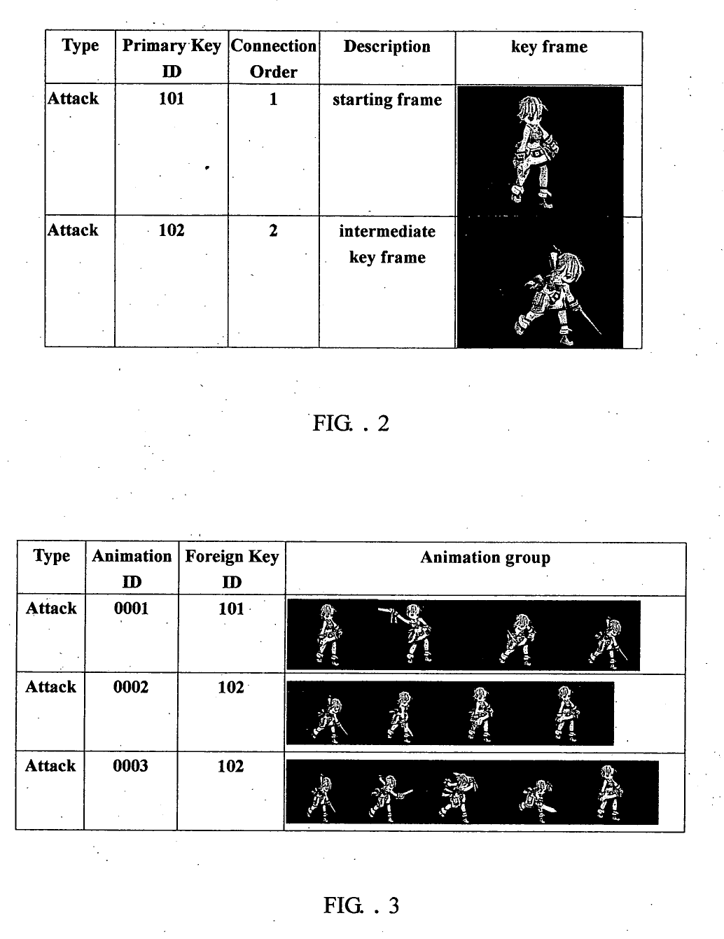

Referring to FIG. 2, it schematically depicts an animation connection table of starting frames and intermediate key frames and associated elements of two attacks of a computer game. As shown, one attack has a primary key ID 101 and a first connection order as a starting frame, and the other attack has a primary key ID 102 and a second connection order as an intermediate key frame.

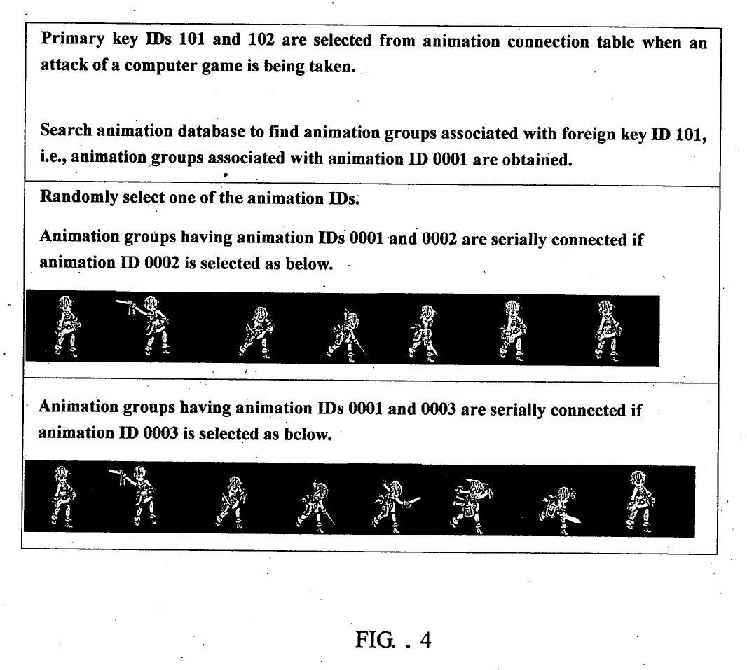

Referring to FIG. 3, it schematically depicts an animation database which is created in the step D. The animation database contains a plurality of animation groups each having a first frame identical to one connecting frame and a last frame identical to the other connecting frame. Also, each animation group has an animation ID (e.g., 0001) and a foreign key ID (e.g., 101).

Referring to FIG. 4, it schematically depicts a portion of the animation groups of a series of stages of movement when an attack of a computer game is being taken in response to instructing the game engine to search the animation database. In detail, primary key IDs 101 and 102 are selected. Next, search the animation database to find animation groups associated with foreign key ID 101, i.e., animation groups associated with animation ID 0001 are obtained. Next, find animation ID(s) associated with foreign key ID 102, i.e., animation IDs 0002 and 0003 are obtained. Next, randomly select one of the animation IDs. For example, animation groups of a series of stages of movement (i.e., animation groups having animation IDs 0001 and 0002 are serially connected) are shown in an upper portion of FIG. 4 if animation ID 0002 is selected. Alternatively, animation groups of a series of stages of movement (i.e., animation groups having animation IDs 0001 and 0003 are serially connected) are shown in a lower portion of FIG. 4 if animation ID 0003 is selected.

The invention can be carried out by slightly modifying existing programs. Thus, time and money are saved in producing a quality computer game.

While the invention herein disclosed has been described by means of specific embodiments, numerous modifications and variations could be made thereto by those skilled in the art without departing from the scope and spirit of the invention set forth in the claims.

What is claimed is:

1. A method for producing a computer game comprising:
setting a plurality of connecting frames between a starting frame and an intermediate key frame and a plurality of connecting frames between the intermediate key frame and an ending frame of an animation file to be created for playing the computer game;
producing a plurality of intermediate animation groups of a series of stages of movement between the starting frame and the ending frame;
numbering the animation groups;
creating an animation database containing the animation groups each having a first frame identical to one connecting frame and a last frame identical to another connecting frame;
instructing a game engine to search the animation database;
finding a starting frame of the animation file the same as that indicated by the instruction;
randomly selecting a subsequent frame associated with the starting frame; and
serially connecting the starting frame and the subsequent frame.
